(19) United States
(12) Patent Application Publication
(10) Pub. No.: US 2018/0078450 A1
(43) Pub. Date: Mar. 22, 2018

(54) HAND-HELD, DUAL MODE SELF-CARE DEVICE

(71) Applicants: Lisa Marie Erikson, Broomfield, CO (US); Jared William Brown, Broomfield, CO (US)

(72) Inventors: Lisa Marie Erikson, Broomfield, CO (US); Jared William Brown, Broomfield, CO (US)

(21) Appl. No.: 15/708,423

(22) Filed: Sep. 19, 2017

Related U.S. Application Data
(60) Provisional application No. 62/397,829, filed on Sep. 21, 2016.

(51) Int. Cl. A61H 23/02; A61H 9/00

(52) U.S. Cl. CPC A61H 23/0263; A61H 9/0057; A61H 2201/0153; A61H 2201/1207; A61H 2201/5023

(57) ABSTRACT

Disclosed is a hand-held, dual mode self-care device for use by individuals for care of their bodies. A three-way switch selectively powers either a vibrational pad at one end of the device or a vacuum pump at the opposite end of the device from the same electric motor. This provides compact packaging of the device to make it portable, as well as easy to use while providing both a vibrational function and a suction function for the regions consisting but not limited to soft tissue consisting of tendons, ligaments, fascia, skin, fibrous tissues, fat, synovial membranes and muscles.

### BACKGROUND

Self-care tools are beneficial for individuals to be able to perform care on their own bodies. A vibrational tool can be used to relax tight muscles, increase blood flow, increase neuromuscular proprioception and increase muscular recruitment. It can also be used with or without tension or motion and applied to underlying tissues to break up subcutaneous adhesions, decrease fascial adherance, and reduce scar tissue that accumulates with inflammation, injuries, and connective tissue disorders. A suction tool can be used to separate adhered skin, as well as to increase blood flow, improve local tissue nutrition and hydration, and restore pliability and motion to the underlying soft tissue, which includes tendons, ligaments, fascia, skin, fibrous tissues, fat, and synovial membranes, and muscles. Providing these functions in hand-held devices makes it easy for an individual to work on his or herself, as well as makes the device portable for use at home, on trips, or at sporting events. Disclosed is a hand-held, dual mode self-care device that uses a single electric motor to provide both vibrational and suction functions in a compact, easy to use, portable design.

### SUMMARY

An embodiment of the present invention may therefore comprise a self-care device comprising: an electric motor; an eccentric mass selectively coupled to a first output of the electric motor; a vacuum impeller selectively coupled to a second output of the electric motor on an opposite end of the electric motor from the first output of the electric motor; a three-way switch that has a neutral position that turns the self-care device off, a first position that powers the electric motor to rotate the eccentric mass to provide a vibrational function of the self-care device, and a second position that powers the electric motor to rotate the vacuum impeller to provide a suction function of the self-care device.

An embodiment of the present invention may therefore further comprise a method of providing a vibrational function and a suction function for a self-care device comprising: providing an electric motor; providing a three-way switch; selectively coupling an eccentric mass to a first output of said electric motor when said three-way switch is moved to a first position so that said electric motor rotates said eccentric mass to provide said vibrational function of said self-care device; selectively coupling a vacuum impeller to a second output of said electric motor on an opposite end of said electric motor from said first output of said electric motor when said three-way switch is moved to a second position so that said electric motor rotates said vacuum impeller to provide said suction function of said self-care device.

### BRIEF DESCRIPTION OF THE DRAWINGS

FIG. 1 is a schematic of a self-care device with vibrational and suction functions.

FIG. 2 is a schematic of a self-care device that utilizes a first one-way clutch and a second one-way clutch to provide vibrational and suction functions.

FIG. 3 is a schematic of a self-care device that utilizes a first sliding collar and a second sliding collar to provide vibrational and suction functions.

FIG. 4 is a schematic of a self-care device with detachable vibrational pads of various sizes to provide a vibrational function to smaller or larger areas of a user's body.

FIG. 5 is a schematic of a self-care device with detachable shrouds of various sizes for vacuum impeller to provide a suction function to smaller or larger areas of a user's body.

### DETAILED DESCRIPTION OF THE EMBODIMENTS

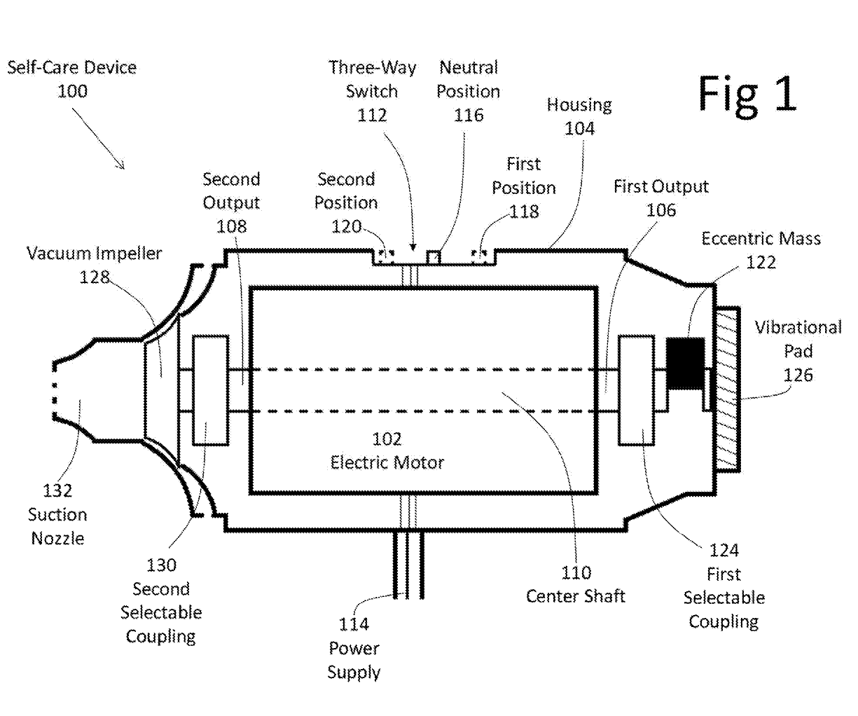

FIG. 1 is a schematic of a self-care device 100 with vibrational and suction functions. Electric motor 102 is mounted in housing 104 and has first output 106 and second output 108 on opposite sides. First output 106 and second output 108 may be opposite ends of a center shaft 110 of electric motor 102. Three-way switch 112 is mounted on an exterior of housing 104, and is wired to power supply 114. Power supply 114 may be an electric cord, and can be configured to plug into a variety of electrical outlets, including by not limited to standard 115V AC outlets found in buildings, and 12V DC outlets found in vehicles. Three-way switch 112 has a neutral position 116 which disconnects electric motor 102 from power supply 114 and turns off self-care device 100 when not in use. Three-way switch 112 also has a first position 118 and a second position 120 which power the device. First position 118 of three-way switch 112 powers electric motor 102 to spin an eccentric mass 122 from first output 106 through a first selectable coupling 124. When eccentric mass 122 is spun by electric motor 102, it produces a vibration that is transferred to a vibrational pad 126 that provides a vibrational function of self-care device 100. Vibrational pad 126 can be pressed against the user's body to relieve muscle tightness. Second position 120 of three-way switch 112 powers electric motor 102 to spin a vacuum impeller 128 from second output 108 through a second selectable coupling 130. When vacuum impeller 128 is spun by electric motor 102, it pumps air from a suction nozzle 132 that provides a suction function of self-care device 100. Suction nozzle 132 can be placed against the skin of a user to separate adhered skin. In this way, self-care device 100 uses a single electric motor 102 and a three-way switch 112 to either provide a vibrational function through spinning eccentric mass 122 to provide vibration to vibrational pad 126, or to provide a suction function through spinning vacuum impeller 128 to pump air from suction nozzle 132. This way, self-care device 100 can be a small, hand-held, portable device for consumers, while providing two functions for self-care.

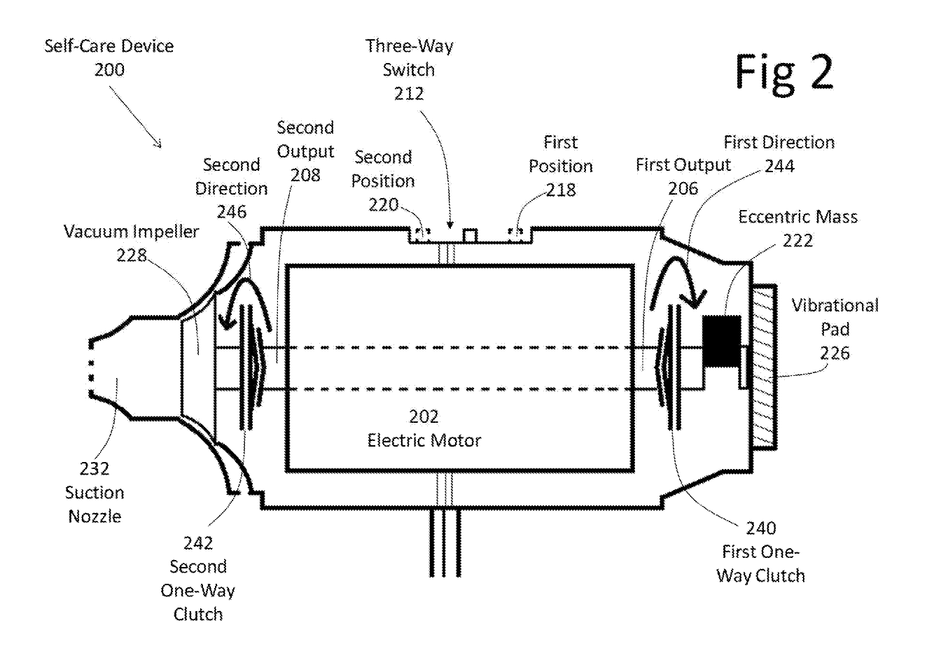

FIG. 2 is a schematic of a self-care device 200 that utilizes a first one-way clutch 240 and a second one-way clutch 242 to provide vibrational and suction functions. When three-way switch 212 is moved to first position 218, electric motor 202 spins in a first direction 244. First output 206 of electric motor 202 is connected to first one-way clutch 240, which engages only when electric motor 202 spins in first direction 244. First one-way clutch 240 is connected to eccentric mass 222, which in turn spins when three-way switch 212 is in first position 218 and first one-way clutch 240 is engaged. This provides vibration to vibrational pad 226 that provides a vibrational function of self-care device 200. When three-way switch 212 is moved to second position 220, electric motor 202 spins in a second direction 246, which is in an opposite rotational direction to first direction 244. Second output 208 of electric motor 202 is connected to second one-way clutch 242, which engages only when electric motor 202 spins in second direction 246. Second one-way clutch 242 is connected to vacuum impeller 228, which in turn spins when three-way switch 212 is in second position 220 and second one-way clutch 242 is engaged. This pumps air from suction nozzle 232, providing a suction function of self-care device 200. The use of first one-way clutch 240 and second one-way clutch 242 to selectively engage eccentric mass 222 or vacuum impeller 228 depending on the direction of rotation of electric motor 202 provides both vibrational and suction functions for self-care device 200 in a compact and simple package. As shown in FIG. 2, first one-way clutch 240 and second one-way clutch 242 may consist of friction clutches with ramps that engage when spun in a certain direction, but may also be sprag clutches, ratcheting mechanisms, or other devices that provide the function of a one-way clutch.

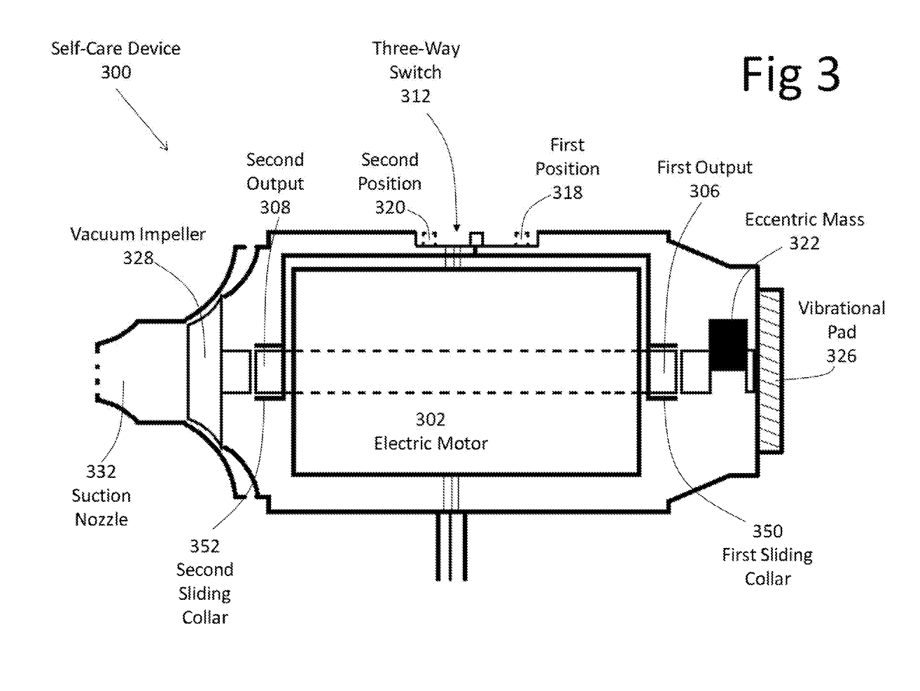

FIG. 3 is a schematic of a self-care device 300 that utilizes a first sliding collar 350 and a second sliding collar 352 to provide vibrational and suction functions. When three-way switch 312 is moved toward first position 318, first sliding collar 350 slides along first output 306 of electric motor 302 and engages eccentric mass 322. This engagement can be achieved by using shaft splines that interface with first sliding collar 350, or any other similar method. When three-way switch 312 reaches first position 318, first sliding collar 350 has locked eccentric mass 322 to first output 306 of electric motor 302, so that electric motor 302 spins eccentric mass 322. Eccentric mass 322 provides vibration to vibrational pad 326 to provide a vibrational function of self-care device 300. When three-way switch 312 is moved toward second position 320, second sliding collar 352 slides along second output 308 of electric motor 302 and engages vacuum impeller 328. When three-way switch 312 reaches second position 320, second sliding collar 352 has locked vacuum impeller 328 to second output 308 of electric motor 302, so that electric motor 302 spins vacuum impeller 328. Vacuum impeller 328 pumps air from suction nozzle 332, providing a suction function of self-care device 300. Engaging first sliding collar 350 and second sliding collar 352 with three-way switch 312 provides an alternative method to selectively spin eccentric mass 322 or vacuum impeller 328 with electric motor 302 to provide both vibrational and suction functions for self-care device 300 in a compact and simple package.

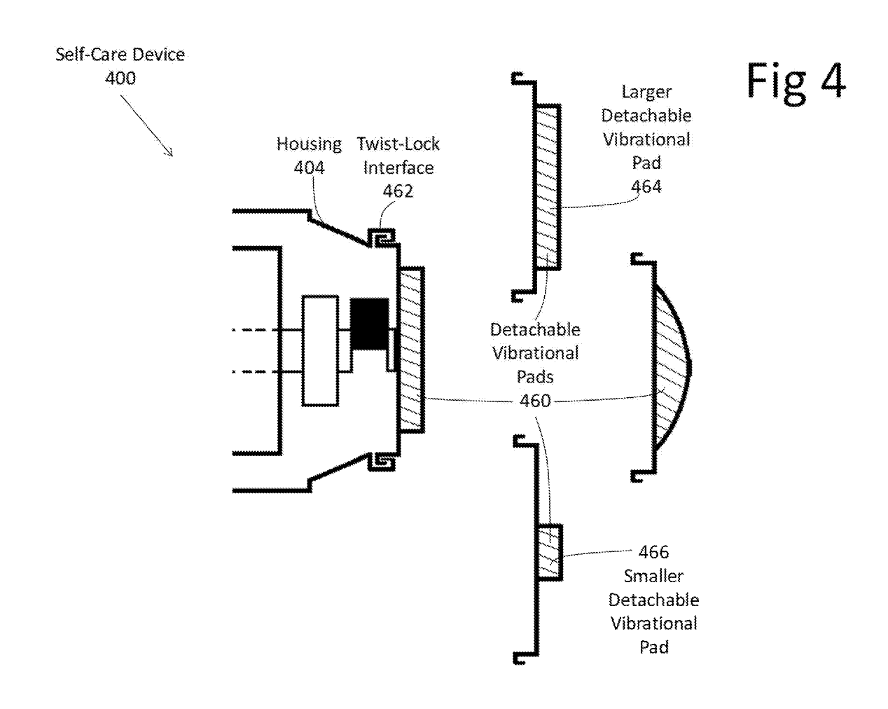

FIG. 4 is a schematic of a self-care device 400 with detachable vibrational pads 460 of various sizes to provide a vibrational function to smaller or larger areas of a user's body. Detachable vibrational pads 460 attach to housing 404 and are easily removable. The method of attachment to housing 404 can be as simple as a twist-lock interface 462, but other methods of attachment can also be used. This allows a user of self-care device 400 to both replace worn-out detachable vibrational pads 460, as well as to tailor a certain size of detachable vibrational pad 460 to a particular use. To use the vibrational function of self-care device 400 over a larger area of the body, the user can select a larger detachable vibrational pad 464. For higher-intensity use of the vibrational function of self-care device 400 at a single point, the user can select a smaller detachable vibrational pad 466. Detachable vibrational pads 460 may also be made of different shapes and materials.

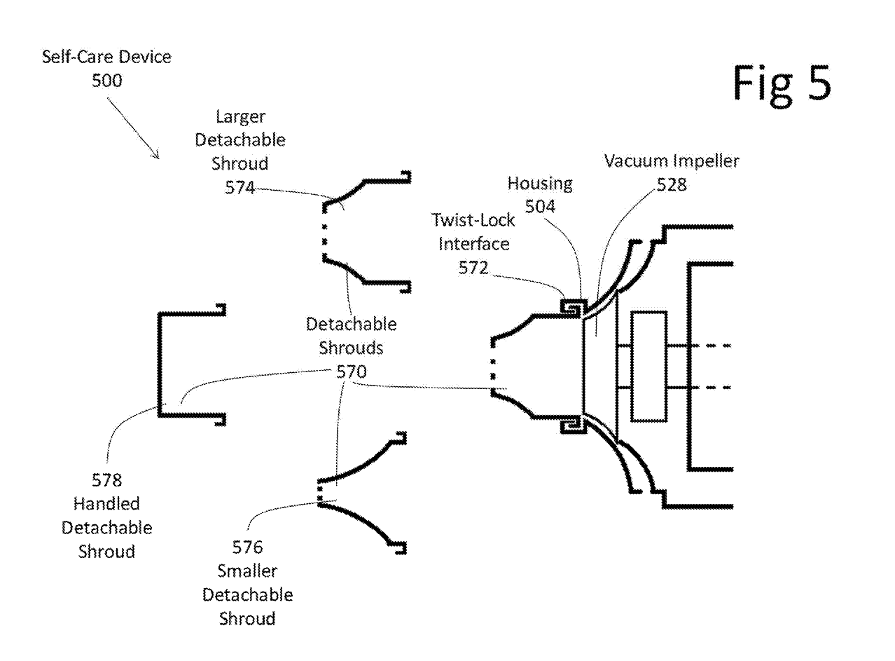

FIG. 5 is a schematic of a self-care device 500 with detachable shrouds 570 of various sizes for vacuum impeller 528 to provide a suction function to smaller or larger areas of a user's body. Detachable shrouds 570 attach to housing 504 and are easily removable. The method of attachment to housing 504 can be as simple as a twist-lock interface 572, but other methods of attachment to housing 504 can be used. This allows a user of self-care device 500 to both replace worn-out detachable shrouds 570, as well as to tailor a certain size of detachable shroud 570 to a particular use. To use the suction function of self-care device 500 over a larger area of skin, the user can select a larger detachable shroud 574. For higher-intensity use of the suction function of self-care device 500 at a single point, the user can select a smaller detachable shroud 576. Additionally, a handled detachable shroud 578 can be used, which provides a place for a user's hand to push when self-care device 500 is used in vibrational mode.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A self-care device comprising:
an electric motor;
an eccentric mass selectively coupled to a first output of said electric motor;
a vacuum impeller selectively coupled to a second output of said electric motor on an opposite end of said electric motor from said first output of said electric motor;
a three-way switch that has a neutral position that turns said self-care device off, a first position that powers said electric motor to rotate said eccentric mass to provide a vibrational function of said self-care device, and a second position that powers said electric motor to rotate said vacuum impeller to provide a suction function of said self-care device.

2. The self-care device of claim 1 where said eccentric mass is selectively coupled to said first output of said electric motor by a first one-way clutch that engages in a first rotational direction, and said vacuum impeller is selectively coupled to said second output of said electric motor by a second one-way clutch that engages in a second rotational direction; where said first position of said three-way switch rotates said electric motor in said first rotational direction, engaging said first one-way clutch and rotating said eccentric mass, and said second position of said three-way switch rotates said electric motor in said second rotation direction, engaging said second one-way clutch and rotating said vacuum impeller.

3. The self-care device of claim 1 where said eccentric mass is selectively coupled to said first output of said electric motor by a first sliding collar, and said vacuum impeller is selectively coupled to said second output of said electric motor by a second sliding collar; where movement of said three-way switch from said neutral position toward said first position engages said first sliding collar to lock said eccentric mass to said electric motor, so that said electric motor rotates said eccentric mass when said three-way switch reaches said first position, and movement of said three-way switch from said neutral position toward said second position engages said second sliding collar to lock said vacuum impeller to said electric motor, so that said electric motor rotates said vacuum impeller when said three-way switch reaches said second position.

4. The self-care device of claim 1 where said eccentric mass has detachable vibrational pads of various sizes to provide said vibrational function to smaller or larger areas of a user's body.

5. The self-care device of claim 1 where said vacuum impeller has detachable shrouds of various sizes to provide said suction function to smaller or larger areas of a user's body.

6. The self-care device of claim 5 where a detachable shroud of said vacuum impeller comprises a handle for a user's hand when said vibrational function of said self-care device is in use.

7. A method of providing a vibrational function and a suction function for a self-care device comprising:
providing an electric motor;
providing a three-way switch;
selectively coupling an eccentric mass to a first output of said electric motor when said three-way switch is moved to a first position so that said electric motor rotates said eccentric mass to provide said vibrational function of said self-care device;
selectively coupling a vacuum impeller to a second output of said electric motor on an opposite end of said electric motor from said first output of said electric motor when said three-way switch is moved to a second position so that said electric motor rotates said vacuum impeller to provide said suction function of said self-care device.

8. The method of claim 7 where said process of selectively coupling said eccentric mass to said first output of said electric motor comprises:
rotating said electric motor in a first direction when said three-way switch is moved to said first position;
providing a first one-way clutch that engages when said electric motor rotates in said first direction to lock said first output of said electric motor to said eccentric mass.

9. The method of claim 7 where said process of selectively coupling said vacuum impeller to said second output of said electric motor comprises:
rotating said electric motor in a second direction when said three-way switch is moved to said second position;
providing a second one-way clutch that engages when said electric motor rotates in said second direction to lock said second output of said electric motor to said vacuum impeller.

10. The method of claim 7 where said process of selectively coupling said eccentric mass to said first output of said electric motor comprises:
moving a first sliding collar when said three-way switch is moved to said first position that locks said first output of said electric motor to said eccentric mass.

11. The method of claim 7 where said process of selectively coupling said vacuum impeller to said second output of said electric motor comprises:
moving a second sliding collar when said three-way switch is moved to said second position that locks said second output of said electric motor to said vacuum impeller.
